(19) United States
(12) Patent Application Publication
(10) Pub. No.: US 2007/0207280 A1
(43) Pub. Date: Sep. 6, 2007

(54) Animated time delay thermochromic ink display

(76) Inventor: Wynne Wolfe, Arcadia, CA (US)

Correspondence Address: CHRISTIE, PARKER & HALE, LLP, PO BOX 7068, PASADENA, CA, 91109-7068, US

(21) Appl. No.: 11/369,630

(22) Filed: Mar. 6, 2006

(51) Int. Cl. B31B 45/00; B29D 22/00

(52) U.S. Cl. 428/34.1

(57) ABSTRACT

A thermochromic ink display comprises a stepped sequence of permanent graphics images each covered with a separate thermochromic ink layer which is opaque at room temperature. The ink layers have different transition temperatures from opaque to transparent to form a stepped time delay sequence that reveals the graphics images as slightly different figures simulating the sequential motion effect of an animation.

### FIELD OF INVENTION

This invention relates to graphics images applied to containers for holding beverages and to sleeve-like container holders. The various graphics images applied according to principles of this invention are hidden and revealed by temperature-activated thermochromic ink applied to the graphics patterns in a hide-and-reveal format that produces an animated sequence of figures that resemble a motion picture.

### BACKGROUND

Thermochromic materials such as thermochromic ink layers can be applied to a substrate as image layers that hide a non-thermochromic image. Application of heat can cause the thermochromic ink layers to reach their transition temperatures at which they change state from opaque to transparent or colorless, for example. Different thermochromic materials (in different colors, for example) can have different transition temperatures. Thermochromic materials are disclosed in U.S. Pat. No. 5,202,677 to Parker et al.; U.S. Pat. No. 5,805,245 to Davis; and U.S. Pat. No. 5,223,958 to Berry, which are incorporated herein by reference. A ceramic beverage holding cup having a thermochromic time-sequence display is disclosed in U.S. Patent Publication 2002/0097777 to Ronci, also incorporated herein by reference.

### SUMMARY OF THE INVENTION

Briefly, one embodiment of this invention comprises a thermochromic ink display disposed on a beverage container or container holder, either of which is adapted to sense temperature changes caused by a hot medium poured into a container or into a container on which the container holder is positioned. The thermochromic ink display comprises a stepped sequence of permanent graphics images each covered with a separate thermochromic ink layer which is opaque at room temperature. The ink layers have different transition temperatures from opaque to transparent. When a hot beverage is poured into the container, the opaque layers sense temperature changes and transition to transparent in a stepped time delay sequence that reveals the graphics images in a sequence of steps. The graphics images contain slightly different figures that, when revealed in the time delay sequence, simulate the sequential motion effect of an animation.

In one form of the invention, the graphics image can be combined with permanent graphics to produce the appearance and effect of the frames of a film strip or movie reel.

These and other aspects of the invention will be more fully understood by referring to the following detailed description and the accompanying drawings.

### BRIEF DESCRIPTION OF THE DRAWINGS

FIG. 1 is a perspective view showing a beverage container having a stepped thermochromic ink display representing frames of a movie reel in which each frame is covered by a separate thermochromic ink layer each depicted in an opaque state at room temperature.

FIG. 2 is a perspective view showing the same beverage container as illustrated in FIG. 1 but containing a hot beverage that has caused the thermochromic ink layers to transition from opaque to transparent and reveal previously hidden permanent images which are revealed in a stepped time delay sequence forming an animation that progresses from left to right with respect to FIG. 2.

FIG. 3 is a representation of a graphics image display that can be applied to the container or a container holder, which in this instance illustrates three side-by-side frames of a movie reel in which all three frames are covered by separate opaque thermochromic ink layers.

FIG. 4 is a graphics image display illustrating a first progression from that of FIG. 3 showing a first step in a permanent graphics image display that has been revealed by a first thermochromic ink layer having transitioned to transparent at a first lower temperature.

FIG. 5 is a graphics image display illustrating a second step in the progression in which permanent images are revealed when a second thermochromic ink layer has transitioned from opaque to transparent at a second intermediate temperature.

FIG. 6 is a graphics image display illustrating a third step in the progression in which permanent images are revealed when a third thermochromic ink layer has transitioned from opaque to transparent at a third higher temperature.

FIG. 7 is a perspective view showing an alternative form of the invention in which the graphics image display can be applied to a container holder.

### DETAILED DESCRIPTION

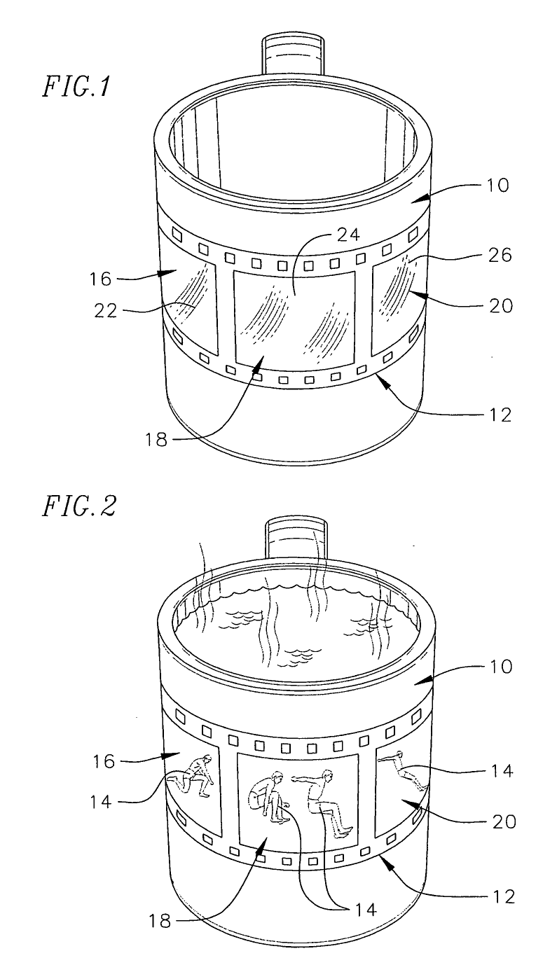

FIGS. 1 and 2 illustrate a beverage container 10 having a thermochromic ink display 12 according to principles of this invention. The thermochromic ink display comprises a sequence of permanent graphics images 14 applied to the outer surface of the beverage container. The sequence of graphics images is presented in separate frames 16, 18 and 20 spaced apart side-by-side progressing generally horizontally across the container. The permanent graphics images are shown hidden in FIG. 1 and revealed in FIG. 2.

The permanent graphics images are covered by separate layers 22, 24 and 26 of thermochromic ink each having a different temperature at which the ink layer transitions from opaque to transparent. FIG. 1 illustrates a room temperature condition in which each of the thermochromic ink layers 22, 24 and 26 is opaque, thereby hiding the underlying permanent images. The thermochromic ink layers each have a different temperature-responsive composition that causes each layer to transition to transparent at increasing, and therefore different, temperatures. In the illustrated embodiment, the thermochromic ink layers have transition temperatures responsive to temperature changes sensed from pouring a hot beverage into the container as illustrated in FIG. 2. FIG. 2 illustrates the condition at which each of the thermochromic ink layers has ultimately transitioned to transparent, and has thereby revealed the underlying images.

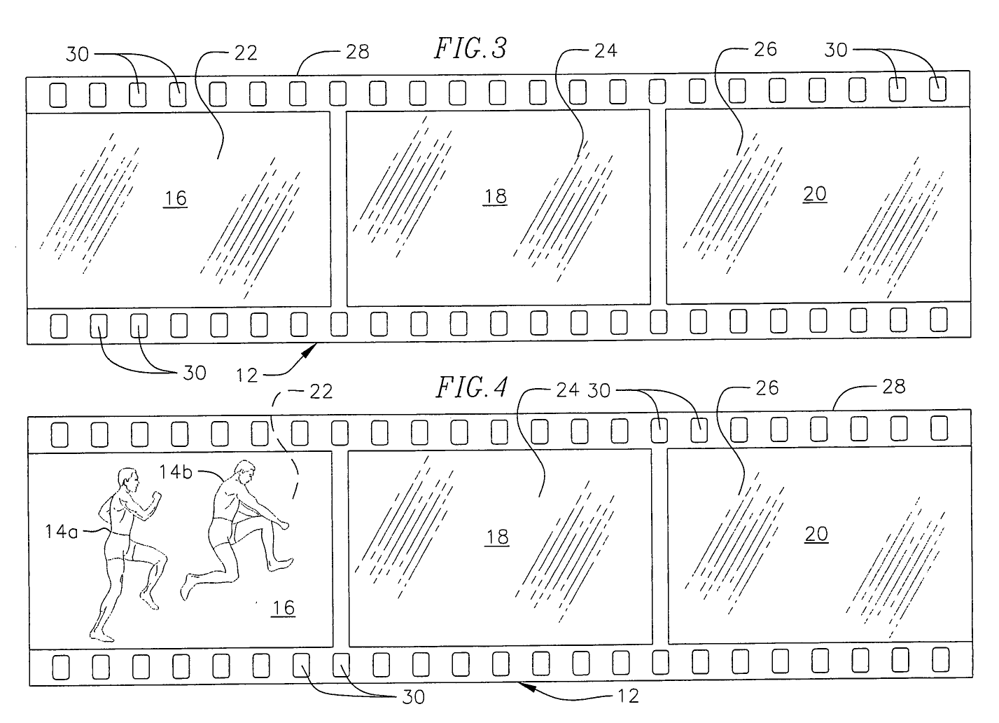

FIGS. 3 through 6 illustrate a time delay sequence of hiding and revealing the permanent graphics images so as to form the effect of a real life animation. The animation is formed by graphics images in the form of side-by-side figures or objects, each so slightly different from the next that they produce the visual effect of an animation when revealed in sequence. The figures in the side-by-side frames are revealed one at a time in a sequence initiated by sensed increasing temperature changes. The sensed temperature changes are the result of the temperature build up in the wall of the beverage container caused by having poured a hot beverage into the container. The drawings depict one example of the graphics images as FIGS. 14a through 14f, illustrating a long jumper in slightly different poses which, when revealed in sequence, has the animation effect of real life motion.

The animation effects are enhanced by permanent graphics applied to the outer surface of the container to depict a film strip 28 with rows of sprocket holes 30 along top and bottom edges of the film strip. The film strip is divided sequentially into the separate frames 16, 18 and 20 progressing from left to right across the graphics display. This or any other similar permanent graphics can be applied to provide the proper overall visual effect of a sequence of scenes to be revealed one at a time progressing across the graphics display. The film strip or movie reel depiction is one example.

FIG. 3 illustrates the graphics display at room temperature at which the thermochromic ink layers 22, 24 and 26 are all opaque and the permanent images represented by the images 14 are hidden.

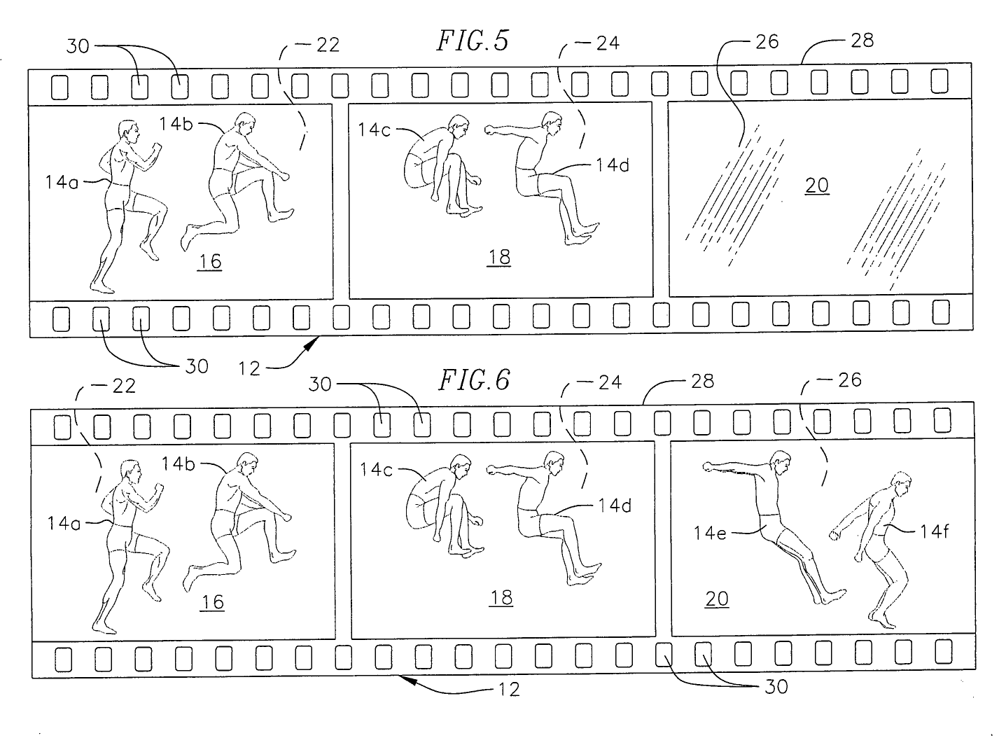

FIG. 4 illustrates the graphics display at a first relatively lower temperature where the first thermochromic ink layer 22 has transitioned to transparent. This has revealed FIGS. 14a and 14b which form the first two images in the animated sequence. Frames 18 and 20 which were covered by different temperature sensitive thermochromic ink layers 24 and 26 remain opaque at the first relatively lower temperature.

FIG. 5 illustrates the graphics display at a second intermediate temperature where the first thermochromic ink layer 22 remains transparent and the second thermochromic layer 24 has transitioned to transparent. This has revealed FIGS. 14c and 14d which form the second set of images in the animated sequence. The frame 20 covered by the third thermochromic ink layer 26 remains opaque at the intermediate temperature.

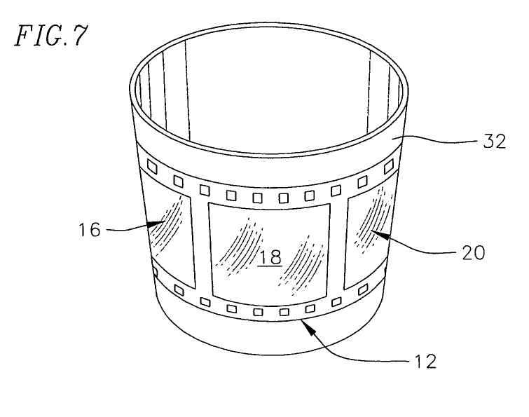

FIG. 6 illustrates the graphics display at a third relatively higher temperature where the first two frames 16 and 18 remain revealed by their related transparent thermochromic ink layers and the third thermochromic ink layer 26 has transitioned to transparent. This has revealed FIGS. 14e and 14f which form the full set of images in the three-step progression of the animated sequence.

In the process of applying the permanent images 14 to the substrate surface, the various figures or objects are formed so that they produce slight variations from one figure to the next so that, when revealed in a time delay sequence progressing from left to right, the hide-and-reveal process simulates the sequential motion effect of an animation. Stated another way, the graphics images contain figures or objects each so slightly different from one another that, when revealed in a stepped progression, they appear to move as real-life objects or figures.

In one embodiment, the thermochromic ink layers are made from thermochromic ink materials having different transition temperatures from opaque to transparent. The thermochromic ink layers are aligned with the transition temperatures progressing higher in sequence from left to right to produce the visual effects depicted in FIGS. 3 through 6. In one embodiment, all ink layers are opaque at room temperature, i.e., up to at least about 100° F. (ambient temperature). The first thermochromic ink layer 22 has a transition temperature of about 45° C. (a range of about 105-110° F.); the second thermochromic ink layer 24 has a transition temperature of about 55° C. (a range of about 125-130° F.); and the third thermochromic ink layer 26 has a transition temperature of about 60° C. (a range of about 145-150° F.). (These transition temperatures are substrate temperatures.)

The thermochromic ink materials useful in producing the visual effects of this invention are available from Chromatic Technologies Incorporated (CTI), Colorado Springs, Colo.

FIG. 7 illustrates an alternative form of the invention in which the graphics display such as that illustrated in FIGS. 1 through 6 can be applied to a beverage container holder 32. The beverage container holder is of generally tubular configuration, having a tapered structure in the well known manner. The holder is preferably made from a flexible liner with an insulating layer disposed around the inside surface for contact with the outer surface of a beverage container. The outer surface of the liner is preferably made from an ink receptive material on which the permanent decorative images can be printed and then covered with the respective layers of temperature-dependent thermochromic ink to produce visual effects similar to those described for FIGS. 1 through 6.

The present invention has been described with respect to an animation time delay sequence of figures progressing from left to right, although the invention also can be carried out by a time delay sequence moving in the opposite direction, or in any other desired time delay sequence that can produce other animated visual effects. An example would be a sequence of animated images that are revealed in a random or deliberate sequence but not necessarily in a linear sequence as described previously. The invention also has been described with respect to human figures each so slightly different from one another when revealed in the stepped progression that they appear to move as real life figures. Similar animated graphics can be produced with inanimate objects to form a real life animation. Examples could be scenes showing various stages of automobile racing or the stretch run of a horse race, for example.

1-10. (canceled)

11. A thermochromic display disposed on a surface of a beverage container or on a holder for a beverage container, the thermochromic display comprising:
a series of first, second and third side-by-side frames each formed as a separate permanent image of a border enclosing first, second and third image areas, respectively;
separate and distinct first, second and third graphics images permanently applied to the first, second and third image areas, respectively, the permanent graphics images comprising mutually related scenes or figures that form a non-temperature-indicating animated sequence in a progression from the first to the second to the third graphics image;
a first layer of thermochromic ink overlying the first graphics image inside the first frame;
a second layer of thermochromic ink overlying the second graphics image inside the second frame; and
a third layer of thermochromic ink overlying the third graphics image inside the third frame;
the first, second and third layers of thermochromic ink each opaque at room temperature;
the thermochromic ink layers each having different active temperatures at which they transition from opaque to transparent, respectively, the thermochromic ink layers positioned on the image areas so that the active temperatures of the thermochromic ink layers transition from opaque to transparent to reveal the first, second and third permanent graphics images in a time delay sequence to produce the sequential motion effect of an animation progressing from the first frame to the second frame to the third frame in response to the thermochromic ink layers sensing the accumulated temperature of a liquid in the beverage container.

12. The display according to claim 11 in which the borders of the frames are in the form of a linear film strip.

13. The display according to claim 11 in which the active temperatures progress from a lower temperature to an intermediate temperature to a higher temperature in sequence from the first frame to the second frame to the third frame.
